(19) United States
(12) Patent Application Publication
(10) Pub. No.: US 2025/0192461 A1
(43) Pub. Date: Jun. 12, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tetsuya MIYAMURA, Mie (JP)

(21) Appl. No.: 18/845,895

(22) PCT Filed: Mar. 1, 2023
(86) PCT No.: PCT/JP2023/007661

§ 371 Date: Sep. 11, 2024

(30) Foreign Application Priority Data
Mar. 22, 2022 (JP) 2022-045194

(51) Int. Cl. H01R 12/70

(52) U.S. Cl. CPC H01R 12/707

(57) ABSTRACT

A fixing portion includes a first inserting portion and a second inserting portion. The first inserting portion includes a deflecting portion resiliently deformable in a width direction of the through-hole and to be inserted into the through-hole and a retaining portion projecting in the width direction from the deflecting portion on a tip part of the deflecting portion and configured to suppress the deflecting portion from coming out from the through-hole. The second inserting portion is arranged side by side with the first inserting portion in a depth direction orthogonal to the width direction in the through-hole. A second creepage surface along an inner peripheral edge of the through-hole, out of the second inserting portion, is larger than a first creepage surface along the inner peripheral edge of the through-hole, out of the first inserting portion.

### TECHNICAL FIELD

The present disclosure relates to a connector.

### BACKGROUND

Patent Document 1 discloses a board connector in which a housing is mounted on a printed board using snap-fit terminals. The snap-fit terminal includes a bar-like leg portion and a wide locking portion formed on a tip part of the leg portion. The snap-fit terminal is fixed to the printed board using solder after the locking portion is passed through a through hole of the printed board while the leg portion is temporarily resiliently deformed in a width direction.

### PRIOR ART DOCUMENT

### Patent Document

Patent Document 1: JP 2009-252696 A

### SUMMARY OF THE INVENTION

### Problems to be Solved

However, in Patent Document 1, a width of the through hole is set to be larger than a width of the leg portion since the locking portion of the snap-fit terminal needs to be passed. In such a case, if the tip part of the snap-fit terminal is passed through the through hole, a large uneven gap is formed between the leg portion and the inner surface of the through hole.

If the tip part of the snap-fit terminal is soldered to the printed board in such a state, there is a concern that the solder hardly flows into the large gap between the leg portion and the inner surface of the through hole and does not evenly flow on the outer surface of the snap-fit terminal and the snap-fit terminal cannot be satisfactorily fixed to the printed board.

Further, if the large gap is formed between the leg portion and the inner surface of the through hole, the snap-fit terminal may be shifted in the width direction in the through hole. Thus, there is a concern that it is difficult to determine the position of the snap-fit terminal with respect to the printed board.

A connector of a first aspect of the present disclosure was completed on the basis of the above situation and it is aimed to provide a connector satisfactorily fixable by solder.

A connector of a second aspect of the present disclosure was completed on the basis of the above situation and it is aimed to suppress a position shift with respect to a circuit board.

### Means to Solve the Problem

The first aspect of the present disclosure is directed to a connector with a fixing bracket to be inserted into a rectangular through-hole formed in a circuit board, the fixing bracket being fixed to the circuit board using solder, the fixing bracket including a first bracket having a deflecting portion resiliently deformable in a width direction of the through-hole, the deflecting portion being inserted into the through-hole, and a retaining portion projecting in the width direction from the deflecting portion on a tip part of the deflecting portion, the retaining portion suppressing the deflecting portion from coming out from the through-hole, and a second bracket arranged side by side with the first bracket in a depth direction orthogonal to the width direction in the through-hole, and a second creepage surface along an inner peripheral edge of the through-hole, out of the second bracket, is larger than a first creepage surface along the inner peripheral edge of the through-hole, out of the first bracket.

The second aspect of the present disclosure is directed to a connector with a fixing bracket to be inserted into a through-hole formed in a circuit board, the fixing bracket including a first bracket having a deflecting portion resiliently deformable in a width direction of the through-hole, the deflecting portion being inserted into the through-hole, and a retaining portion projecting toward one side in the width direction from the deflecting portion on a tip part of the deflecting portion, the retaining portion suppressing the deflecting portion from coming out from the through-hole, and a second bracket arranged side by side with the first bracket in a depth direction orthogonal to the width direction in the through-hole, and a dimension in the width direction of the second bracket in the through hole being set to be larger than a dimension in the width direction of the first bracket in the through hole.

### Effect of the Invention

According to the first aspect of the present disclosure, satisfactory fixing by solder is possible. According to the second aspect of the present disclosure, a position shift with respect to a circuit board can be satisfactorily suppressed.

### BRIEF DESCRIPTION OF THE DRAWINGS

FIG. 1 is a perspective view of a connector of the present disclosure.

FIG. 2 is a perspective view of a first terminal fitting and a second terminal fitting.

FIG. 3 is a perspective view of a third terminal fitting.

FIG. 4 is a partial enlarged back view of a left end part of the connector of the present disclosure when viewed from behind.

FIG. 5 is a section along A-A in FIG. 4.

FIG. 6 is a partial enlarged view showing a state where the lower end of a retaining portion is in contact with a through-hole.

FIG. 7 is a partial enlarged view showing a state where the retaining portion is inserted in the through-hole.

FIG. 8 is a partial enlarged view showing a state where the retaining portion is passed downward through the through-hole.

FIG. 9 is a perspective view of a third terminal fitting of a second embodiment.

FIG. 10 is a section along B-B in FIG. 9.

FIG. 11 is a perspective view of a third terminal fitting of a third embodiment.

FIG. 12 is a section along C-C in FIG. 11.

FIG. 13 is a section of a fixing portion of another embodiment cut in a direction orthogonal to an insertion direction into a through-hole.

FIG. 14 is a section of a fixing portion of another embodiment cut in a direction orthogonal to an insertion direction into a through-hole.

### DETAILED DESCRIPTION TO EXECUTE THE INVENTION

### Description of Embodiments of Present Disclosure

First, embodiments of the present disclosure are listed and described.
(1) The connector of the first aspect of the present disclosure is provided with a fixing bracket to be inserted into a rectangular through-hole formed in a circuit board, the fixing bracket being fixed to the circuit board using solder. The fixing bracket includes a first bracket and a second bracket. The first bracket includes a deflecting portion resiliently deformable in a width direction of the through-hole, the deflecting portion being inserted into the through-hole, and a retaining portion projecting in the width direction from the deflecting portion on a tip part of the deflecting portion, the retaining portion suppressing the deflecting portion from coming out from the through-hole. The second bracket is arranged side by side with the first bracket in a depth direction orthogonal to the width direction in the through-hole. A second creepage surface along an inner peripheral edge of the through-hole, out of the second bracket, is larger than a first creepage surface along the inner peripheral edge of the through-hole, out of the first bracket. According to this configuration, regions along the inner peripheral edge of the through hole can be increased on the fixing bracket, whereby ranges where the solder easily adheres to both the circuit board and a terminal fitting can be increased. Therefore, the fixing bracket can be easily and satisfactorily fixed to the circuit board.
(2) Preferably, a creepage region on a projecting side of the retaining portion, out of the first creepage surface, and a creepage region on the projecting side of the retaining portion, out of the second creepage surface, are aligned in the width direction. According to this configuration, the regions along the inner peripheral edge of the through hole can be increased more on the fixing bracket.
(3) Preferably, the fixing bracket includes a conductive portion to be conductively contacted by a mating terminal, and a cross-sectional area of the second bracket orthogonal to an insertion direction into the through-hole is larger than a cross-sectional area of the first bracket orthogonal to the insertion direction. Since a cross-sectional area of the fixing bracket can be increased as compared to the case where only the first bracket is provided, electrical resistance can be reduced and currents and signals can be easily and satisfactorily exchanged with a mating terminal.
(4) Preferably, a dimension of the second bracket is larger than a dimension of the first bracket in the depth direction. According to this configuration, since the regions along the inner peripheral edge of the through hole can be increased, the fixing bracket can be more easily and satisfactorily fixed to the circuit board by soldering.
(5) Preferably, both end edges in the width direction of the second bracket are along the inner peripheral edge of the through-hole. According to this configuration, since the regions along the inner peripheral edge of the through hole on the second bracket are largest, the fixing bracket can be more easily and satisfactorily fixed to the circuit board by soldering and the fixing bracket can be positioned in the width direction by the second bracket.
(1) The connector of the second aspect of the present disclosure is provided with a fixing bracket to be inserted into a through-hole formed in a circuit board. The fixing bracket includes a first bracket and a second bracket. The first bracket includes a deflecting portion resiliently deformable in a width direction of the through-hole, the deflecting portion being inserted into the through-hole, and a retaining portion projecting toward one side in the width direction from the deflecting portion on a tip part of the deflecting portion, the retaining portion suppressing the deflecting portion from coming out from the through-hole. The second bracket is arranged side by side with the first bracket in a depth direction orthogonal to the width direction in the through-hole. A dimension in the width direction of the second bracket in the through hole is set to be larger than a dimension in the width direction of the first bracket in the through hole. According to this configuration, even if a gap is formed in the width direction between the through-hole and the first bracket, a position shift of the fixing bracket in the width direction can be suppressed by the second bracket having a larger width than the first bracket.
(2) Preferably, both end surfaces in the width direction of the second bracket are closely facing an inner surface of the through hole. According to this configuration, the fixing bracket can be positioned in the width direction by the second bracket.
(3) W1 denotes a dimension in the width direction of the first bracket, W2 denotes a dimension in the width direction of the second bracket, D1 denotes a dimension in the depth direction of the first bracket and D2 denotes a dimension in the depth direction of the second bracket. At this time, a cross-sectional secondary moment I2 of the second bracket expressed by Equation (2) is preferably larger than a cross-sectional secondary moment I1 of the first bracket expressed by Equation (1).

$$I 1 = ( W {1}^{3} \times D 1 ) / 12 \qquad ( 1 )$$

$$I 2 = ( W {2}^{3} \times D 2 ) / 12 \qquad ( 2 )$$

According to this configuration, since the second bracket can be made less likely to be deformed than the first bracket in the width direction, a position shift of the fixing bracket in the width direction can be more effectively suppressed or prevented.
(4) Preferably, the dimension D1 in the depth direction of the first bracket is larger than the dimension D2 in the depth direction of the second bracket. According to this configuration, since the cross-sectional secondary moment is proportional to a cube of the dimension in the width direction, sufficiently large rigidity in the width direction of the second bracket can be maintained even if the dimension D2 of the second bracket is made smaller than that of the first bracket. By increasing the dimension D1 of the first bracket, a dimension in the depth direction of the retaining portion can also increase and an engagement area of the retaining portion with the through-hole can be increased. In this way, a function of locking the retaining portion to the through-hole can be more easily enhanced.

### DETAILS OF EMBODIMENTS OF PRESENT DISCLOSURE

### First Embodiment

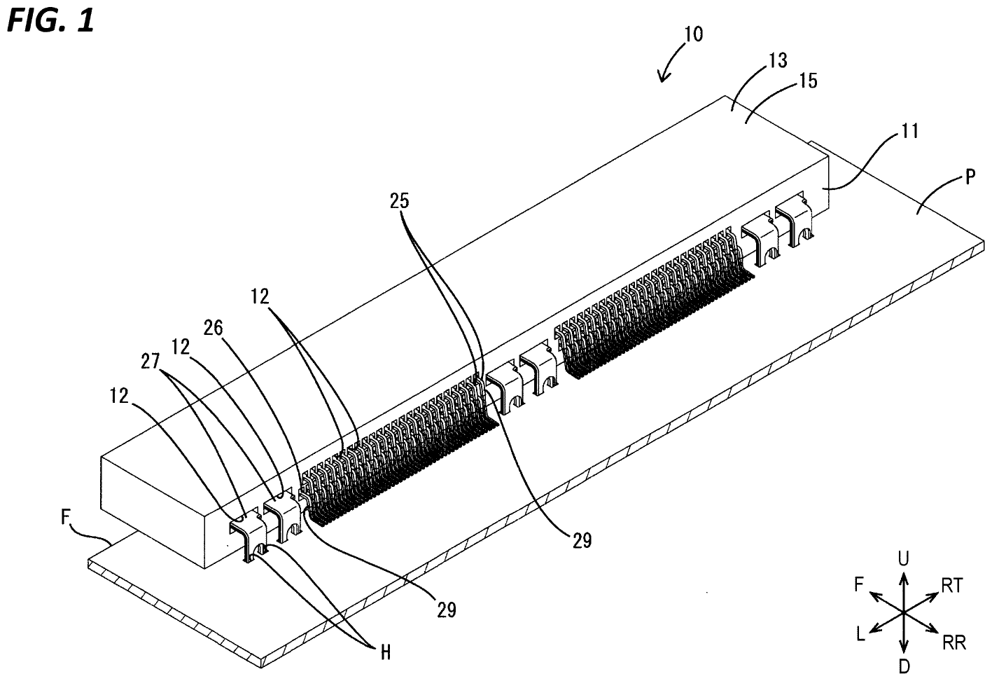

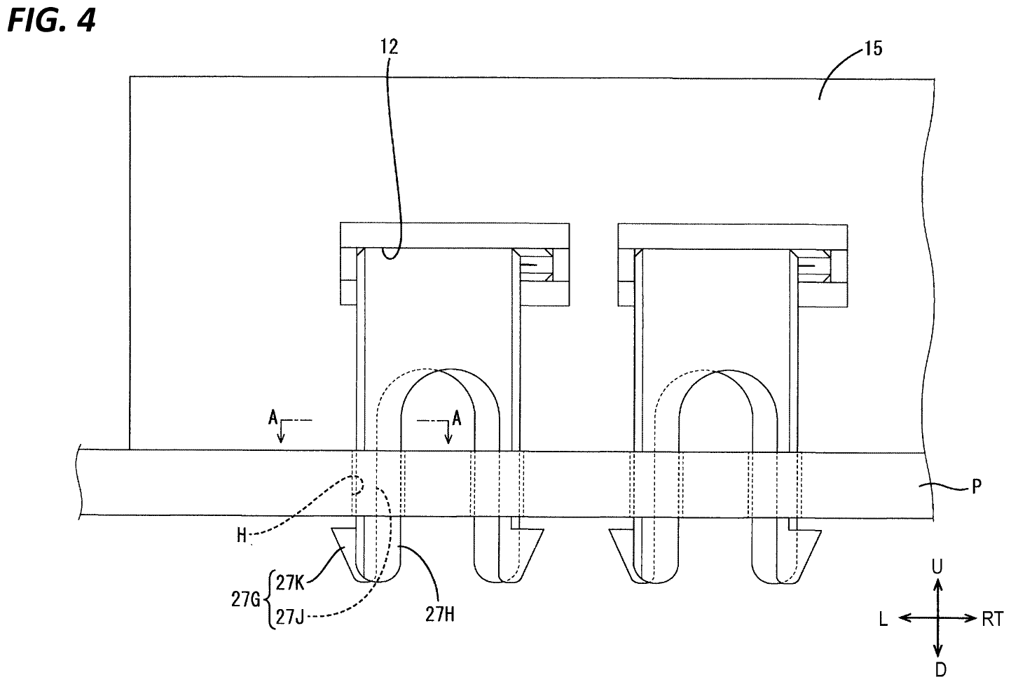

A first specific embodiment of the present disclosure is described below with reference to FIGS. 1 to 8. Note that, in the following description, a back side and a frontal side in FIG. 4 are defined as a front side and a rear side concerning a front-rear direction. The front side is a side where a connector 10 is connected to an unillustrated mating connector. Upper and lower sides shown in FIG. 4 are directly defined as upper and lower sides concerning a vertical direction. Left and right sides shown in FIG. 4 are directly defined as left and right sides concerning a lateral direction.

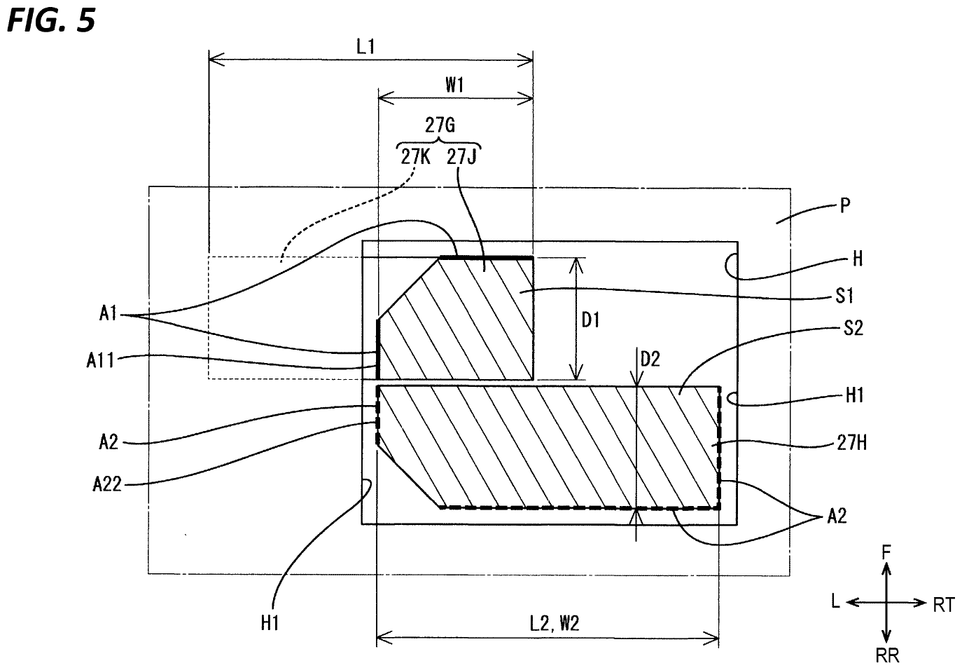

As shown in FIG. 1, the connector 10 is placed on an end part of the upper surface of a circuit board P and fixed to the circuit board P. The circuit board P is formed with a plurality of through-holes H penetrating in a plate thickness direction. These through-holes H have a rectangular outer shape (see FIG. 5). A width direction in these through-holes H is the lateral direction, and a depth direction is defined as the front-rear direction. The through-holes H are disposed at positions slightly behind an end edge F of the circuit board P and formed side by side in a row in the lateral direction. Specifically, four through-holes H arranged in the lateral direction are set as one group, and three groups are arranged while being spaced apart by a predetermined distance.

The connector 10 is provided with a housing 15 made of synthetic resin, a plurality of first terminal fittings 25, a plurality of second terminal fittings 26, and a plurality of third terminal fittings 27. The housing 15 is a single component including a terminal holding portion 11 and a receptacle 13 in the form of a rectangular tube extending forward from the outer edge of the terminal holding portion 11. The terminal holding portion 11 is in the form of a wall rising perpendicularly from the upper surface of the circuit board P, and a wall thickness direction thereof is oriented in the front-rear direction. The terminal holding portion 11 is formed with a plurality of press-fit holes 12 penetrating through the terminal holding portion 11 in the front-rear direction.

The plurality of first terminal fittings 25, the plurality of second terminal fittings 26 and the plurality of third terminal fittings 27 are mounted through the terminal holding portion 11 from behind by being press-fit into the press-fit holes 12.

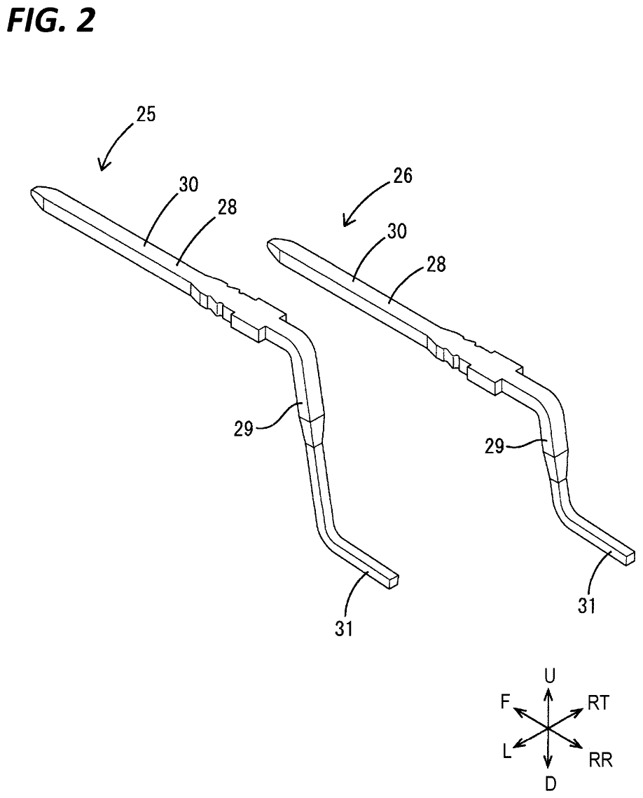

As shown in FIG. 2, the first and second terminal fittings 25, 26 are formed by bending elongated bar materials and each include a conductive portion 28 extending in the front-rear direction and to be passed through the terminal holding portion 11 and a board connecting portion 29 extending downward from the rear end of the conductive portion 28. A front part of the conductive portion 28 is accommodated in the receptacle 13 and functions as a tab 30 capable of conductively contacting a mating terminal (not shown). The board connecting portion 29 is arranged behind the terminal holding portion 11 (see FIG. 1). A lower end part of the board connecting portion 29 serves as a contact portion 31 horizontally projecting rearward and to be brought into contact with a pattern (not shown) formed on a surface of the circuit board P. The board connecting portion 29 of the first terminal fitting 25 is formed to be longer than the board connecting portion 29 of the second terminal fitting 26. Thus, the conductive portion 28 of the first terminal fitting 25 is press-fit into the press-fit hole 12 in an upper stage, and the conductive portion 28 of the second terminal fitting 26 is press-fit into the press-fit hole 12 in a lower stage (see FIG. 1).

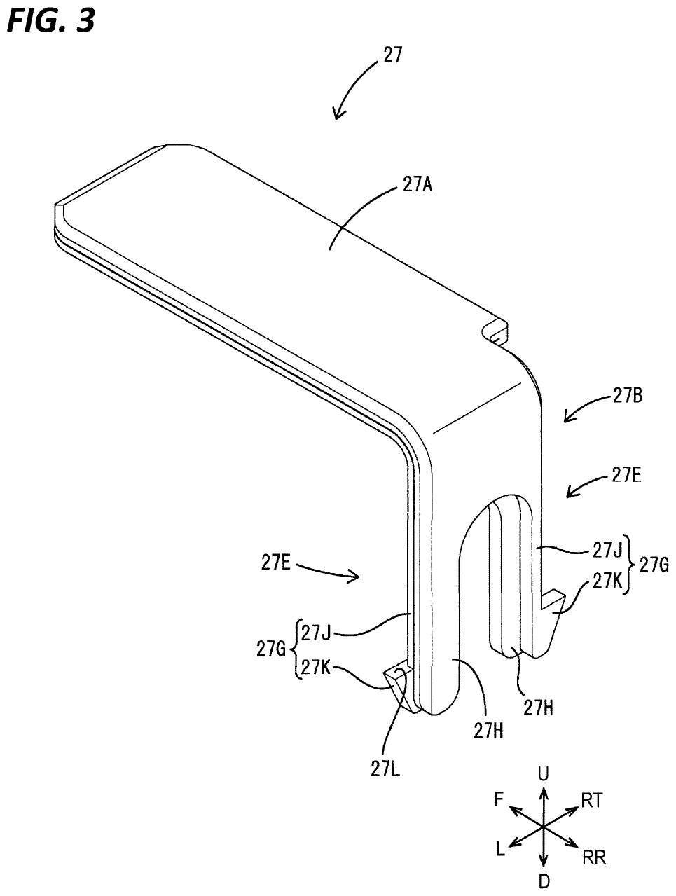

As shown in FIG. 3, the third terminal fitting 27 is formed by press-working a flat metal plate. Each third terminal fitting 27 includes a conductive portion 27A extending in the front-rear direction and penetrating through the terminal holding portion 11 in the front-rear direction and a hanging portion 27B extending downward from the rear end of the conductive portion 27A.

The conductive portion 27A is so formed that parts of the metal plate folded into two are overlapped with a plate thickness direction oriented in the vertical direction. Specifically, the conductive portion 27A is formed such that two parts of the metal plate overlapped in the vertical direction are coupled on the right end edges, out of both lateral end edges. A front part of the conductive portion 27A is accommodated into the receptacle 13 with the plate thickness oriented in the vertical direction, and has a function of conductively contacting a mating terminal (not shown). Deburring is applied to the front end edge and the both lateral end edges of the conductive portion 27A.

The hanging portion 27B includes a pair of fixing portions 27E, which are fixing brackets extending downward respectively from both left and right end parts of the rear end edge of the conductive portion 27A. Since these fixing portions 27E are arranged to be inverted from each other in the front-rear direction and lateral direction and have the same configuration, the left fixing portion 27E is described below, but the right fixing portion 27E is not described.

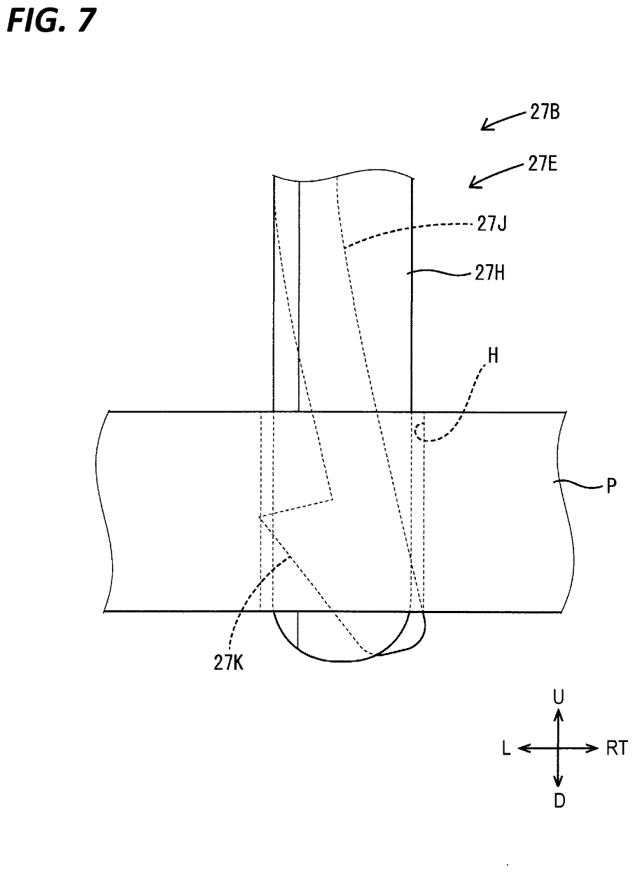

The fixing portion 27E includes a first inserting portion 27G, which is a first bracket, and a second inserting portion 27H, which is a second bracket. The first inserting portion 27G includes a deflecting portion 27J in the form of a column extending downward in a part of the hanging portion 27B connected to the rear end of the lower part of the metal plate of the conductive portion 27A and a retaining portion 27K projecting leftward from the deflecting portion 27J on a lower end part (tip part) of the deflecting portion 27J. The deflecting portion 27J is inserted into the through-hole H from above and resiliently deformable in the lateral direction (see FIG. 7). The retaining portion 27K is so formed that a leftward projecting dimension gradually increases toward an upper side from the lower end of the deflecting portion 27J. A locking surface 27L orthogonal to an extension direction (vertical direction) of the deflecting portion 27J is formed on the upper end of the retaining portion 27K. The left edge of the front surface of the deflecting portion 27J is deburred. Note that the right edge of the rear surface of the deflecting portion 27J on the right side is deburred.

The second inserting portion 27H is in the form of a column extending downward in a part of the hanging portion 27B connected to the rear end of the upper part of the metal plate of the conductive portion 27A with a plate thickness direction oriented in the front-rear direction. The left edge of the rear surface of the second inserting portion 27H is deburred. Note that the right edge of the front surface of the second inserting portion 27H on the right side is deburred. In the through-hole H, the second inserting portion 27H is arranged side by side with and adjacent to the first inserting portion 27G in the front-rear direction (depth direction in the through-hole H) orthogonal to the lateral direction (width direction in the through-hole H) (see FIG. 5). A lateral dimension of the second inserting portion 27H is larger than that of the deflecting portion 27J of the first inserting portion 27G (see FIG. 5). A dimension L1 from the left end of the retaining portion 27K of the first inserting portion 27G to the right end of the deflecting portion 27J is equal to a lateral dimension L2 of the second inserting portion 27H (see FIG. 5). In the lateral direction, the left end surface of the first inserting portion 27G and that of the second inserting portion 27H are aligned in position (see FIG. 5). The lower end of the first inserting portion 27G and that of the second inserting portion 27H are aligned in position in the vertical direction (see FIG. 4).

An example of a mounting process of the connector 10 thus formed on the circuit board P is described. First, the connector 10 is so arranged above the circuit board P that the fixing portions 27E of the respective third terminal fittings 27 are located above the respective through-holes H. In the circuit board P, paste solder is applied in advance to a pattern to be contacted by the first, second and third terminal fittings 25, 26 and 27. Then, the connector 10 is brought closer to the circuit board P and the fixing portions 27E are inserted into the respective through-holes H.

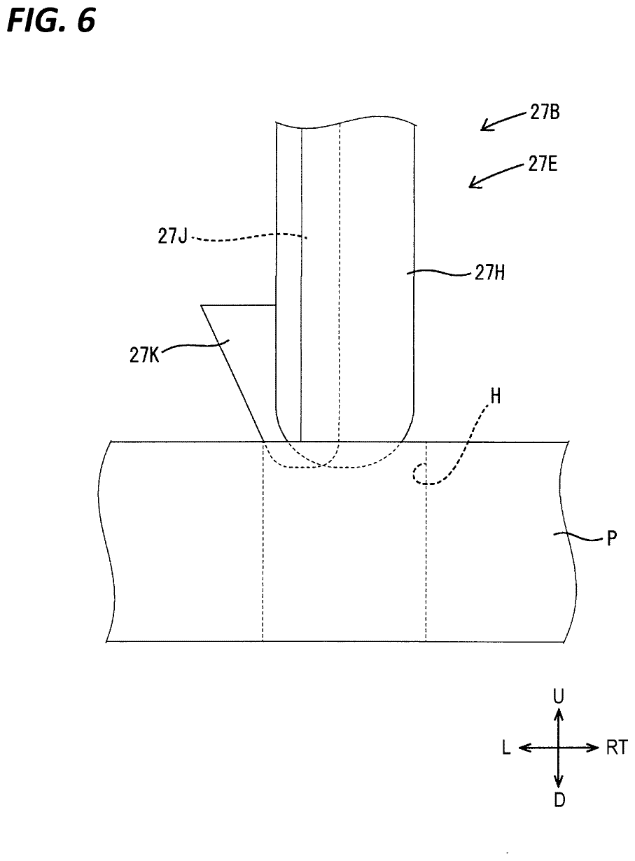

Specifically, as shown in FIG. 6, a lower end part of each retaining portion 27K contacts either one of both widthwise end edges of the through-hole H (the lower end part of the retaining portion 27K contacts the left end edge of the through-hole H in FIG. 6). If the fixing portion 27E is further inserted into each through-hole H, each retaining portion 27K is pressed by the end edge of the through-hole H in contact therewith. In this way, the deflecting portion 27J is resiliently deformed in the width direction of the through-hole H (see FIG. 7).

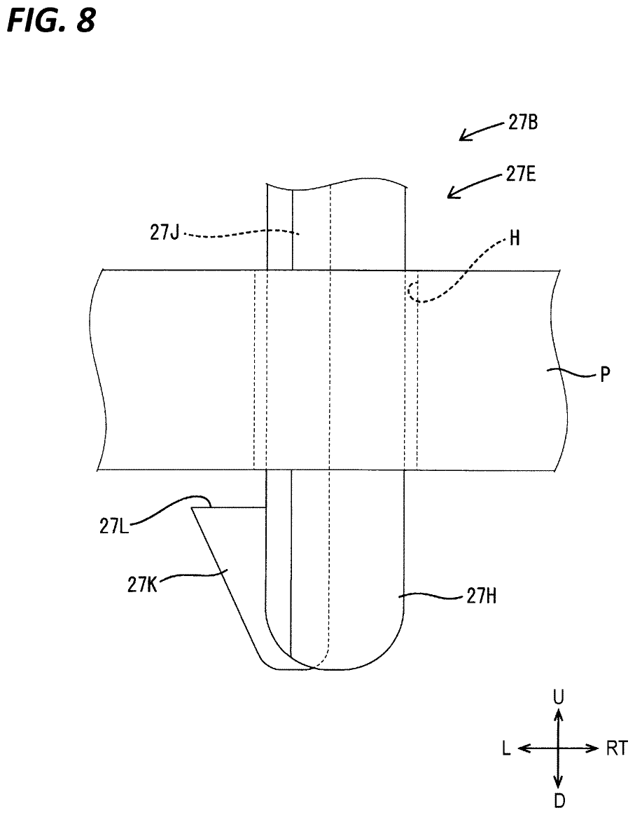

If each retaining portion 27K passes downward through the through-hole H, the deflecting portion 27J resiliently returns and the locking surface 27L of each retaining portion 27K is arranged at a position facing the lower surface of the circuit board P (see FIG. 8). In this way, each retaining portion 27K is arranged at a position lockable to the lower end edge of the through-hole H and suppresses the deflecting portion 27J from coming out from the through-hole H. By this, even if the coplanarity (flatness) of the respective contact portions 31 of the plurality of first terminal fittings 25 and the plurality of second terminal fittings 26 is not satisfactory, the respective contact portions 31 can be reliably brought into contact with the pattern formed on the surface of the circuit board P. If the circuit board P having the connector 10 mounted thereon is thrown into a reflow furnace, the paste solder melts and the fixing portions 27E and the respective contact portions 31 are fixed to the pattern formed on the surface of the circuit board P.

As shown in FIG. 5, the first inserting portion 27G has first creepage surfaces A1 (parts indicated by thick lines in FIG. 5) along the inner peripheral edge of the through-hole H. The second inserting portion 27H has second creepage surfaces A2 (parts indicated by dotted lines in FIG. 5) along the inner peripheral edge of the through-hole H. Here, extending along the inner peripheral edge of the through-hole H means a state parallel to the inner peripheral edge of the through-hole H at a position closer to the inner peripheral edge of the through-hole H than a center of the through-hole H when viewed from an insertion direction into the through-hole H. The second creepage surfaces A2 are larger than the first creepage surfaces A1.

A creepage region A11 on a projecting side of the retaining portion 27K, out of the first creepage surfaces A1, and a creepage region A22 on the projecting side of the retaining portion 27K, out of the second creepage surfaces A2, are aligned in the width direction of the through-hole H. A cross-sectional shape S2 of the second inserting portion 27H orthogonal to the insertion direction into the through-hole H is larger than a cross-sectional shape S1 of the deflecting portion 27J of the first inserting portion 27G orthogonal to the insertion direction. Both end edges of the second inserting portion 27H in the width direction of the through-hole H are along the inner peripheral edge of the through-hole H. Further, both end surfaces (second creepage surfaces A2 on both ends in the width direction) in the width direction of the second inserting portion 27H are respectively closely facing inner surfaces H1 located on both ends in the width direction of the through-hole H. Here, closely facing means a state facing toward the inner peripheral edge of the through-hole H at a position closer to the inner peripheral edge of the through-hole H than the center of the through-hole H when viewed from the insertion direction into the through-hole H.

A dimension of the deflecting portion 27J of the first inserting portion 27G in the width direction of the through-hole H is defined as W1 and a dimension of the second inserting portion 27H in the width direction of the through-hole H is defined as W2. A dimension of the deflecting portion 27J of the first inserting portion 27G in the depth direction of the through-hole His defined as D1 and a dimension of the second inserting portion 27H in the depth direction of the through-hole H is defined as D2. A cross-sectional secondary moment I2 of the second inserting portion 27H expressed by Equation (2) shown under Equations 1 in this case is larger than a cross-sectional secondary moment I1 of the first inserting portion 27G expressed by Equation (1) shown under Equations 1.

$$\begin{matrix}[ Equations 1 ] & \\ I 1 = ( W {1}^{3} \times D 1 ) / 12 & ( 1 )\end{matrix}$$

$$I 2 = ( W {2}^{3} \times D 2 ) / 12 \qquad ( 2 )$$

Next, functions of the first embodiment are described.

The connector 10 is provided with the fixing portions 27E to be inserted into the rectangular through-holes H formed in the circuit board P and fixed to the circuit board P using the solder. The fixing portion 27E includes the first and second inserting portions 27G, 27H. The first inserting portion 27G includes the deflecting portion 27J and the retaining portion 27K. The deflecting portion 27J is resiliently deformable in the width direction of the through-hole H and inserted into the through-hole H. The retaining portion 27K projects in the width direction from the deflecting portion 27J on the tip part of the deflecting portion 27J and suppresses the deflecting portion 27J from coming out from the through-hole H. The second inserting portion 27H is arranged side by side with the first inserting portion 27G in the depth direction orthogonal to the width direction in the through-hole H. The second creepage surfaces A2 of the second inserting portion 27H along the inner peripheral edge of the through-hole H are larger than the first creepage surfaces A1 of the first inserting portion 27G along the inner peripheral edge of the through-hole H. According to this configuration, regions along the inner peripheral edge of the through-hole H can be increased on the fixing portion 27E, whereby it is possible to increase ranges where the solder easily adheres to both the circuit board P and the third terminal fitting 27. Therefore, the fixing portion 27E can be easily and satisfactorily fixed to the circuit board P.

The creepage region A11 on the projecting side of the retaining portion 27K project, out of the first creepage surfaces A1, and the creepage region A22 on the projecting side of the retaining portion 27K, out of the second creepage surfaces A2, are aligned in the width direction. According to this configuration, the regions along the inner peripheral edge of the through-hole H can be increased on the fixing portion 27E.

The fixing portion 27E includes the conductive portion 27A to be conductively contacted by the mating terminal, and the cross-sectional shape S2 of the second inserting portion 27H orthogonal to the insertion direction into the through-hole H is larger than the cross-sectional shape S1 of the first inserting portion 27G orthogonal to the insertion direction. Since a total cross-sectional area of the fixing portion 27E can be increased as compared to the case where a dimension in the front-rear direction of the first inserting portion 27G is doubled instead of providing the second inserting portion 27H, electrical resistance can be reduced and currents and signals can be easily and satisfactorily exchanged with the mating terminal.

The both end edges in the width direction of the second inserting portion 27H are along the inner peripheral edge of the through-hole H. According to this configuration, since the regions along the inner peripheral edge of the through-hole H on the second inserting portion 27H are largest, the fixing portion 27E is more easily and satisfactorily fixed to the circuit board P. Along with this, the fixing portion 27E can be positioned in the width direction by the second inserting portion 27H.

The connector 10 is provided with the fixing portions 27E to be inserted into the through-holes H formed in the circuit board P. The fixing portion 27E includes the first and second inserting portions 27G, 27H. The first inserting portion 27G is resiliently deformable in the width direction of the through-hole H. The first inserting portion 27G includes the deflecting portion 27J to be inserted into the through-hole H and the retaining portion 27K projecting toward one side in the width direction from the deflecting portion 27J on the tip part of the deflecting portion 27J and configured to suppress the deflecting portion 27J from coming out from the through-hole H. The second inserting portion 27H is arranged side by side with the first inserting portion 27G in the depth direction orthogonal to the width direction in the through-hole H. The dimension in the width direction of the second inserting portion 27H in the through-hole His set to be larger than that of the first inserting portion 27G in the through-hole H. According to this configuration, even if a gap is formed in the width direction between the through-hole H and the first inserting portion 27G, a position shift of the fixing portion 27E in the width direction can be suppressed by the second inserting portion 27H having a larger width than the first inserting portion 27G.

The both end surfaces in the width direction of the second inserting portion 27H are closely facing the inner surfaces H1 of the through-hole H. According to this configuration, the fixing portion 27E can be positioned in the width direction by the second inserting portion 27H.

W1 denotes the dimension in the width direction of the first inserting portion 27G, W2 denotes the dimension in the width direction of the second inserting portion 27H, D1 denotes the dimension in the depth direction of the first inserting portion 27G and D2 denotes the dimension in the depth direction of the second inserting portion 27H. At this time, the cross-sectional secondary moment I2 of the second inserting portion 27H expressed by Equation (2) is larger than the cross-sectional secondary moment I1 of the first inserting portion 27G expressed by Equation (1).

$$I 1 = ( W {1}^{3} \times D 1 ) / 12 \qquad ( 1 )$$

$$I 2 = ( W {2}^{3} \times D 2 ) / 12 \qquad ( 2 )$$

According to this configuration, since the second inserting portion 27H can be made less likely to be deformed than the first inserting portion 27G in the width direction, a position shift of the fixing portion 27E in the width direction can be more effectively suppressed or prevented.

### Second Embodiment

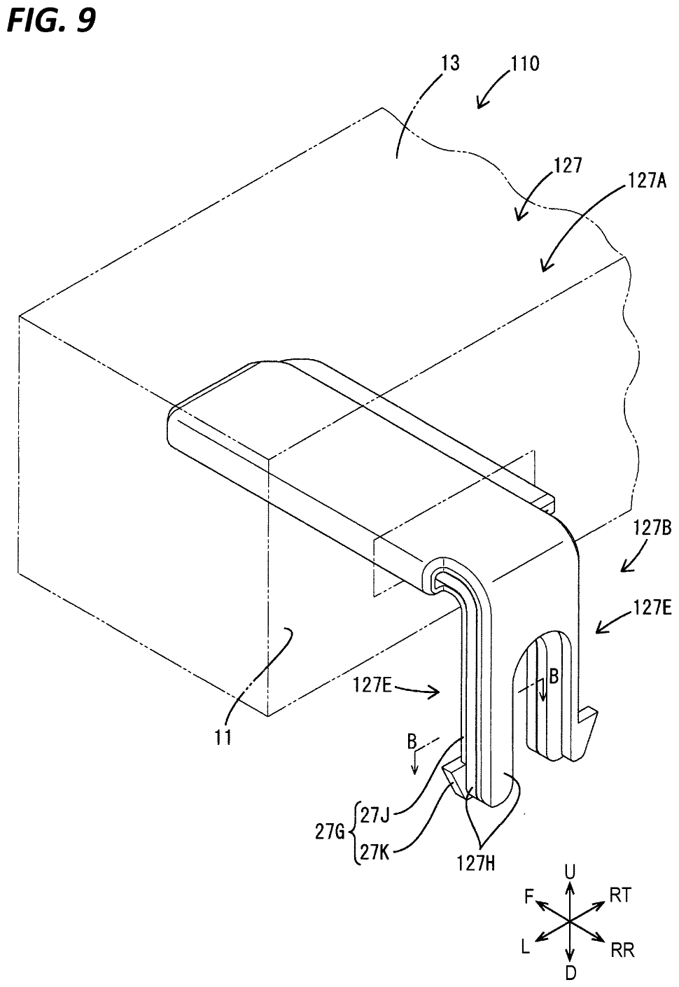

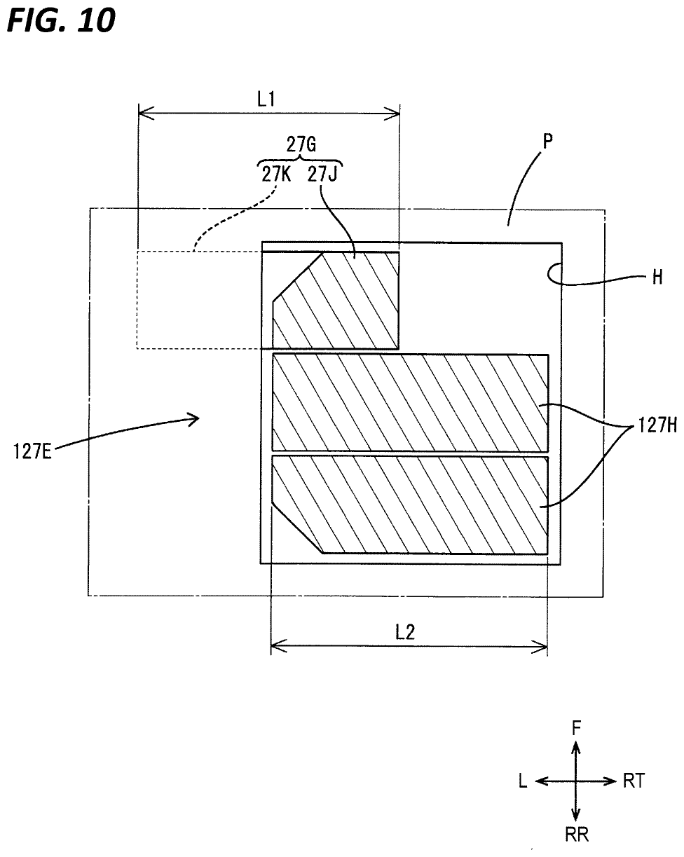

A second specific embodiment of the present disclosure is described below with reference to FIGS. 9 and 10. A connector 110 of the second embodiment differs from the first embodiment in the configuration of a third terminal fitting 127. Since the other configuration is the same as in the first embodiment, the same components are denoted by the same reference signs and the structures, functions and effects thereof are not described. In the second embodiment, an upper side and a lower side in FIG. 10 are defined as a front side and a rear side concerning a front-rear direction. A frontal side and a back side in FIG. 10 are defined as an upper side and a lower side concerning a vertical direction. Left and right sides shown in FIG. 10 are directly defined as left and right sides concerning a lateral direction.

As shown in FIG. 9, the third terminal fitting 127 includes a conductive portion 127A extending in the front-rear direction and passed through a terminal holding portion 11 and a hanging portion 127B extending downward substantially perpendicularly from the rear end of the conductive portion 127A.

The conductive portion 127A is so oriented that a metal plate folded into three are overlapped in the vertical direction. For example, in the conductive portion 127A, the left end edge of a part of the metal plate located on the uppermost position and that of a part of the metal plate located on the lowermost position are coupled. The right end edge of a part of the metal plate located in a vertical center and that of the part of the metal plate located on the lowermost position are coupled. A front part of the conductive portion 127A is accommodated in a receptacle 13 with a plate thickness direction oriented in the vertical direction.

The hanging portion 127B includes a pair of fixing portions 127E, which are fixing brackets extending downward respectively from both left and right end parts of the rear end edge of the conductive portion 127A. Since these fixing portions 127E are arranged to be inverted from each other in the front-rear direction and lateral direction and have the same configuration, the left fixing portion 127E is described below, but the right fixing portion 127E is not described.

The fixing portion 127E includes a first inserting portion 27G, which is first bracket, and two second inserting portions 127H, which are a second bracket. The first inserting portion 27G includes a deflecting portion 27J and a retaining portion 27K. The deflecting portion 27J is in the form of a column extending downward in a part of the hanging portion 127B connected to the part of the metal plate located on the lowermost position of the conductive portion 127A with a plate thickness direction oriented in the front-rear direction. The retaining portion 27K projects leftward from the deflecting portion 27J on a lower end part (tip part) of the deflecting portion 27J.

The two second inserting portions 127H are in the form of columns extending downward in respective parts of the hanging portion 127B connected to the rear end of the part of the metal plate located on the uppermost position of the conductive portion 127A and the rear end of the part of the metal plate located in the vertical center. That is, a total dimension of the two second inserting portions 127H in the front-rear direction is twice the dimension of the first inserting portion 27G. That is, a dimension of one second bracket is larger than that of the first inserting portion 27G (first bracket) (see FIG. 10).

As shown in FIG. 10, the two second inserting portions 127H are arranged side by side with and adjacent to the first inserting portion 27G in the front-rear direction (depth direction in a through-hole H) orthogonal to the lateral direction (width direction in the through-hole H). A dimension in the lateral direction of the second inserting portion 127H is larger than that of the deflecting portion 27J of the first inserting portion 27G. A dimension L1 from the left end of the retaining portion 27K of the first inserting portion 27G to the right end of the deflecting portion 27J is equal to a dimension L2 in the lateral direction of the second inserting portion 127H. In the lateral direction, the left end surface of the first inserting portion 27G and those of the second inserting portions 127H are aligned in position.

In the depth direction of the through-hole H, a dimension of the second inserting portions 127H is larger than that of the deflecting portion 27J of the first inserting portion 27G. According to this configuration, since regions along the inner peripheral edge of the through-hole H can be increased, the fixing portion 127E can be more easily and satisfactorily fixed to a circuit board P by soldering.

### Third Embodiment

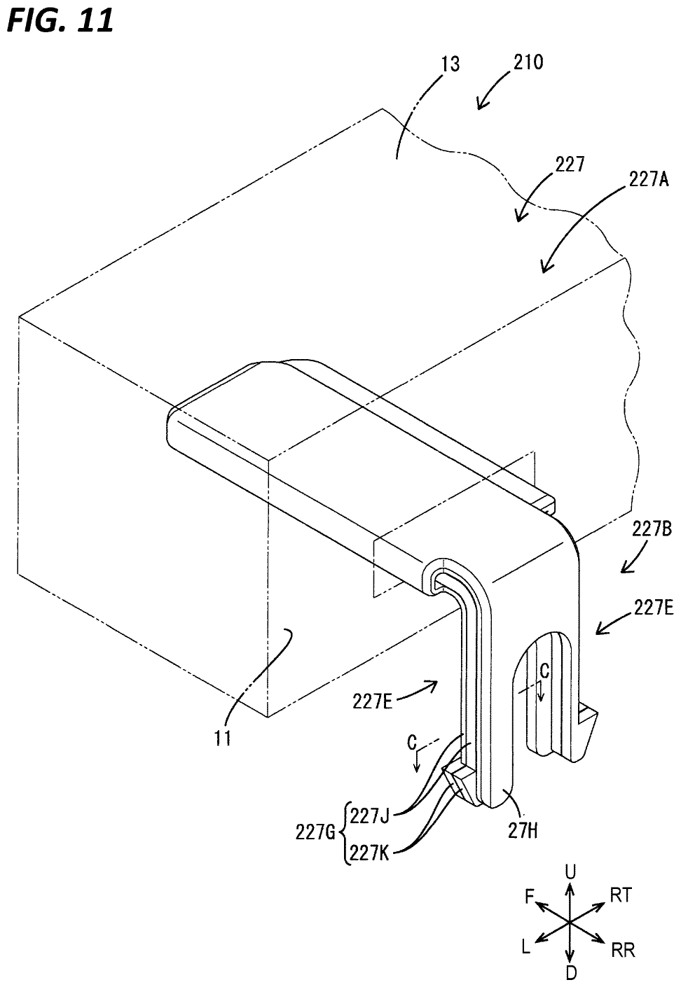

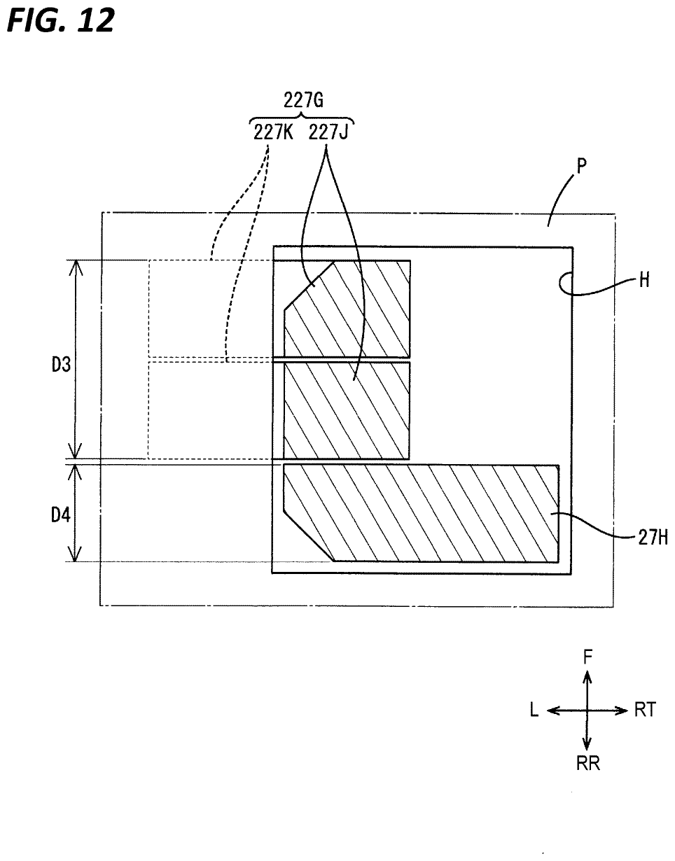

A third specific embodiment of the present disclosure is described below with reference to FIGS. 11 and 12. A connector 210 of the third embodiment differs from the first and second embodiments in the configuration of a third terminal fitting 227. Since the other configuration is the same as in the first and second embodiments, the same components are denoted by the same reference signs and the structures, functions and effects thereof are not described. In the third embodiment, an upper side and a lower side in FIG. 12 are defined as a front side and a rear side concerning a front-rear direction. A frontal side and a back side in FIG. 12 are defined as an upper side and a lower side concerning a vertical direction. Left and right sides shown in FIG. 12 are directly defined as left and right sides concerning a lateral direction.

As shown in FIG. 11, the third terminal fitting 227 includes a conductive portion 227A extending in the front-rear direction and passed through a terminal holding portion 11 and a hanging portion 227B extending downward substantially perpendicularly from the rear end of the conductive portion 227A. The conductive portion 227A is so oriented that a metal plate folded into three are overlapped in the vertical direction.

The hanging portion 227B includes a pair of fixing portions 227E, which are fixing brackets extending downward respectively from both left and right end parts of the rear end edge of the conductive portion 227A. Since these fixing portions 227E are arranged to be inverted from each other in the front-rear direction and lateral direction and have the same configuration, the left fixing portion 227E is described below, but the right fixing portion 227E is not described.

The fixing portion 227E includes a first inserting portion 227G, which is a first bracket, and a second inserting portion 27H, which is a second bracket. One first inserting portion 227G includes two deflecting portions 227J arranged in the front-rear direction and retaining portions 227K arranged in the front-rear direction. The two deflecting portions 227J are in the form of columns extending downward in a part of the hanging portion 227B connected to the rear end of a part of the metal plate located on the lowermost position of the conductive portion 227A and the rear end of a part of the metal plate located in a vertical center with a plate thickness direction oriented in the front-rear direction. The two retaining portions 227K project leftward from the deflecting portions 227J on respective lower end parts (tip parts) of the two deflecting portions 227J.

The second inserting portion 27H is in the form of a column extending downward in a part of the hanging portion 227B connected to the rear end of a part of the metal plate located on the uppermost position of the conductive portion 27A with a plate thickness direction oriented in the front-rear direction. As shown in FIG. 12, in the front-rear direction, a dimension D3 of the first inserting portion 227G is twice as large as a dimension D4 of the second inserting portion 27H, i.e. the dimension D3 of the first inserting portion 227G is larger than the dimension of the second inserting portion 27H.

The dimension D3 of the first inserting portion 227G in a depth direction of the through-hole His larger than the dimension D4 of the second inserting portion 27H in the depth direction of the through-hole H. According to this configuration, since a cross-sectional secondary moment is proportional to a cube of a dimension in the width direction of the through-hole H, sufficiently large rigidity in the width direction of the second inserting portion 27H can be maintained even if the dimension D4 of the second inserting portion 27H is made smaller than that of the first inserting portion 227G. By increasing the dimension D3 of the first inserting portion 227G, dimensions in the depth direction of the retaining portions 227K can also increase and engagement areas of the retaining portions 227K with the through-hole H can be increased. In this way, a function of locking the retaining portions 227K to the through-hole H can be more easily enhanced.

### Other Embodiments

The embodiments disclosed this time should be considered illustrative in all aspects, rather than restrictive. The scope of the present invention is not limited to the embodiments disclosed this time, but is represented by claims and intended to include all changes in the scope of claims and in the meaning and scope of equivalents.

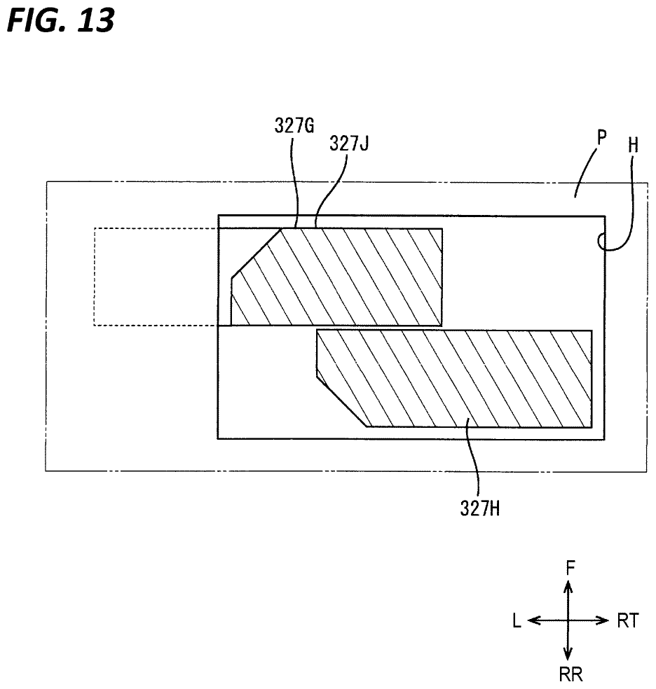

Unlike the first to third embodiments, a deflecting portion 327J of a first inserting portion 327G may be shifted to a left side of a through-hole H and a second inserting portion 327H may be shifted to a right side of the through-hole H as shown in FIG. 13.

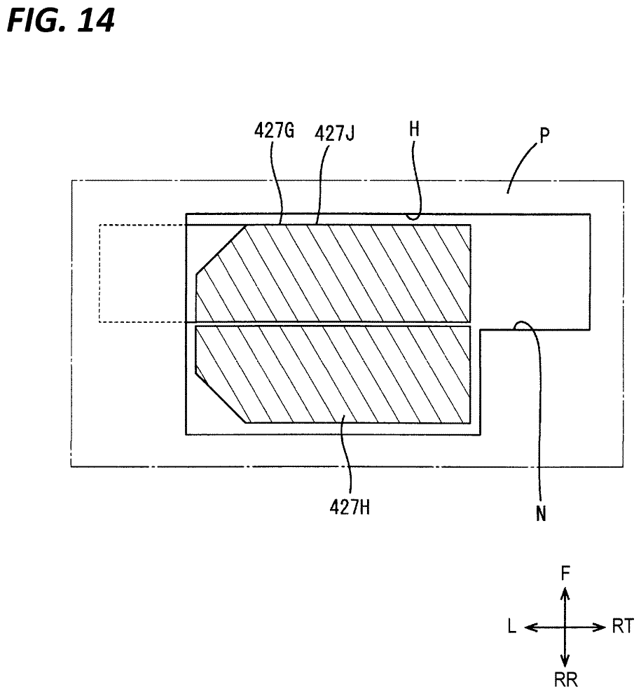

Unlike the first to third embodiments, dimensions in the lateral direction of a deflecting portion 427J of a first inserting portion 427G and a second inserting portion 427H may be set to be equal as shown in FIG. 14. In this case, a through-hole His formed with an escape region N, into which the deflecting portion 427J of the first inserting portion 427G enters when being resiliently deformed.

The outer shape of the through-hole is not limited to the rectangular shape, but may be a circular shape or a polygonal shape.

Unlike the first to third embodiments, the pair of fixing portions may be arranged to be inverted from each other in the lateral direction.

The numbers and arrangement positions of the first, second and third terminal fittings in the connector are not limited to those disclosed in the first embodiment.

### LIST OF REFERENCE NUMERALS

10, 110, 210 . . . connector
11 . . . terminal holding portion
12 . . . press-fit hole
13 . . . receptacle
15 . . . housing
25 . . . first terminal fitting
26 . . . second terminal fitting
27, 127, 227 . . . third terminal fitting
27A, 127A, 227A . . . conductive portion
27B, 127B, 227B . . . hanging portion
27E, 127E, 227E . . . fixing portion (fixing bracket)
27G, 227G, 327G, 427G . . . first inserting portion (first bracket)
27H, 127H, 327H, 427H . . . second inserting portion (second bracket)
27J, 227J, 327J, 427J . . . deflecting portion
27K, 227K . . . retaining portion
27L . . . locking surface
28 . . . conductive portion
29 . . . board connecting portion
30 . . . tab
31 . . . contact portion
A1 . . . first creepage surface
A2 . . . second creepage surface
A11, A12 . . . creepage region
D1, D3 . . . dimension (dimension of first inserting portion in depth direction)
D2, D4 . . . dimension (dimension of second inserting portion in depth direction)
F . . . end edge
H . . . through-hole
H1 . . . inner surface
I1 . . . cross-sectional secondary moment
I2 . . . cross-sectional secondary moment
L1 . . . dimension
L2 . . . dimension
N . . . escape region
P . . . circuit board
S1 . . . cross-sectional area
S2 . . . cross-sectional area
W1 . . . dimension of first inserting portion in width direction
W2 . . . dimension of second inserting portion in width direction

1. A connector, comprising a fixing bracket to be inserted into a through-hole formed in a circuit board, the fixing bracket being fixed to the circuit board using solder,
the fixing bracket including:
a first bracket having a deflecting portion resiliently deformable in a width direction of the through-hole, the deflecting portion being inserted into the through-hole, and a retaining portion projecting in the width direction from the deflecting portion on a tip part of the deflecting portion, the retaining portion suppressing the deflecting portion from coming out from the through-hole; and
a second bracket arranged side by side with the first bracket in a depth direction orthogonal to the width direction in the through-hole,
the first bracket and the second bracket being in the form of flat plates,
parts located in the through hole having a rectangular shape, out of plate surfaces of the first bracket and the second bracket, being facing each other in parallel, and
a second creepage surface along an inner peripheral edge of the through-hole, out of the second bracket, is larger than a first creepage surface along the inner peripheral edge of the through-hole, out of the first bracket.

2. The connector of claim 1, wherein a creepage region on a projecting side of the retaining portion, out of the first creepage surface, and a creepage region on the projecting side of the retaining portion, out of the second creepage surface, are aligned in the width direction.

3. The connector of claim 1, wherein:
the fixing bracket includes a conductive portion to be conductively contacted by a mating terminal, and
a cross-sectional area of the second bracket orthogonal to an insertion direction into the through-hole is larger than a cross-sectional area of the first bracket orthogonal to the insertion direction.

4. The connector of claim 1, wherein a dimension of the second bracket is larger than a dimension of the first bracket in the depth direction.

5. The connector of claim 1, wherein both end edges in the width direction of the second bracket are along the inner peripheral edge of the through-hole.
